(19) United States
(12) Patent Application Publication
(10) Pub. No.: US 2006/0225944 A1
(43) Pub. Date: Oct. 12, 2006

(54) Multiple channel conduit hydraulic noise attenuation device

(76) Inventors: Jack Abner, Columbia City, IN (US); Cliff Krieger, Dryden, MI (US)

Correspondence Address: DYKEMA GOSSETT PLLC, SUITE 300, 39577 WOODWARD AVENUE, BLOOMFIELD HILLS, MI, 48304, US

(21) Appl. No.: 11/102,987

(22) Filed: Apr. 11, 2005

(51) Int. Cl. B62D 5/06

(52) U.S. Cl. 180/417

(57) ABSTRACT

The present invention provides a hose assembly for attenuating noise from fluid pressure pulses in a power steering assembly. The assembly includes a hose disposed between a fluid pump and power steering gear and a tuning conduit disposed within the hose that defines concentric outer and inner fluid passages within the hose. The conduit includes an annular wall and one or more integral cross walls extending between points on the annular wall to subdivide the inner fluid passage into a plurality of parallel, longitudinally extending fluid passages allowing tuning over a broader frequency range.

### FIELD OF THE INVENTION

This invention relates to a power steering assembly and, in particular, to a hose assembly for attenuation of fluid pressure pulses within the power steering assembly.

### DISCLOSURE OF RELATED ART

A conventional power steering assembly includes a pump, a power steering gear and supply and return hose assemblies extending between the pump and steering gear. The supply hose assembly provides pressurized fluid from the pump to the steering gear while the return hose assembly returns fluid from the steering gear to a pump reservoir. In addition, various brackets are used to support and mount the power steering assembly within a vehicle.

The standard design of fluid pumping systems such as power steering assemblies causes pressure fluctuations, ripple or pulses within the fluid at a frequency that is dependent upon the pump speed. The fluid ripple can be a source of audible and objectionable noise and can also excite components along its path to cause them to be secondary generators of such noise. In is therefore desirable to attenuate or suppress fluid-borne noise in hydraulic power systems, especially power steering systems. During normal operation of an automotive power steering system, hydraulic fluid pressure can repetitively vary and thereby generate a pressure dependent wave form that can range substantially in magnitude or amplitude between the upper and lower limit values and induce system vibration.

Conventional attempts at noise attenuation in power steering assemblies having included the use of expansible hoses which can respond to fluid vibrations, as well as the incorporation of a tuning conduit for channeling of the fluid. The tuning conduit may be made from steel or be polymeric. These conventional systems, however, limit tuning to a relatively narrow frequency band thereby limiting their effectiveness.

The inventors herein have recognized a need for a hose assembly for attenuation of fluid pressure pulses in a power steering system that will minimize and/or eliminate one or more of the above-identified deficiencies.

### SUMMARY OF THE INVENTION

The present invention provides a hose assembly for attenuation of fluid pressure pulses in a power steering system.

A hose assembly in accordance with present invention includes a hose disposed between a fluid pump and a power steering gear. The hose transmits fluid between the pump and the power steering gear. The assembly further includes a tuning conduit disposed within the hose. The tuning conduit defines concentric outer and inner fluid passages within the hose. The conduit includes an annular wall and an integral cross wall extending between first and second points on the annular wall to subdivide the inner fluid passage into a plurality of parallel, longitudinally extending fluid passages.

A hose assembly in accordance with the present invention is advantageous as compared to conventional assemblies. The inventive assembly provides a multi-channel tuning conduit that allows for attenuation over a broader frequency range by allowing tuning of individual fluid flow passages within the tuning conduit.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a diagrammatic view of a power steering assembly.

FIG. 2 is a side cross-sectional view of a hose assembly of the power steering assembly of FIG. 1 in accordance with one embodiment of the present invention.

FIG. 3 is a cross-sectional end view of a portion of the hose assembly in FIG. 2.

FIG. 4 is an cross-sectional end view of a portion of a hose assembly in accordance with another embodiment of the present invention.

FIG. 5 is a side cross-sectional view of a hose assembly of the power steering assembly of FIG. 1 in accordance with another embodiment of the present invention.

FIG. 6 is a side cross-sectional view of a hose assembly of the power steering assembly of FIG. 1 in accordance with another embodiment of the present invention.

FIG. 7 is a side cross-sectional view of a hose assembly of the power steering assembly of FIG. 1 in accordance with another embodiment of the present invention.

FIG. 8 is a side cross-sectional view of the end of a hose assembly of the power steering assembly of FIG. 1 in accordance with another embodiment of the present invention.

FIG. 9 is a side cross-sectional view of the end of a hose assembly of the power steering assembly of FIG. 1 in accordance with another embodiment of the present invention.

### DETAILED DESCRIPTION OF EMBODIMENTS OF THE INVENTION

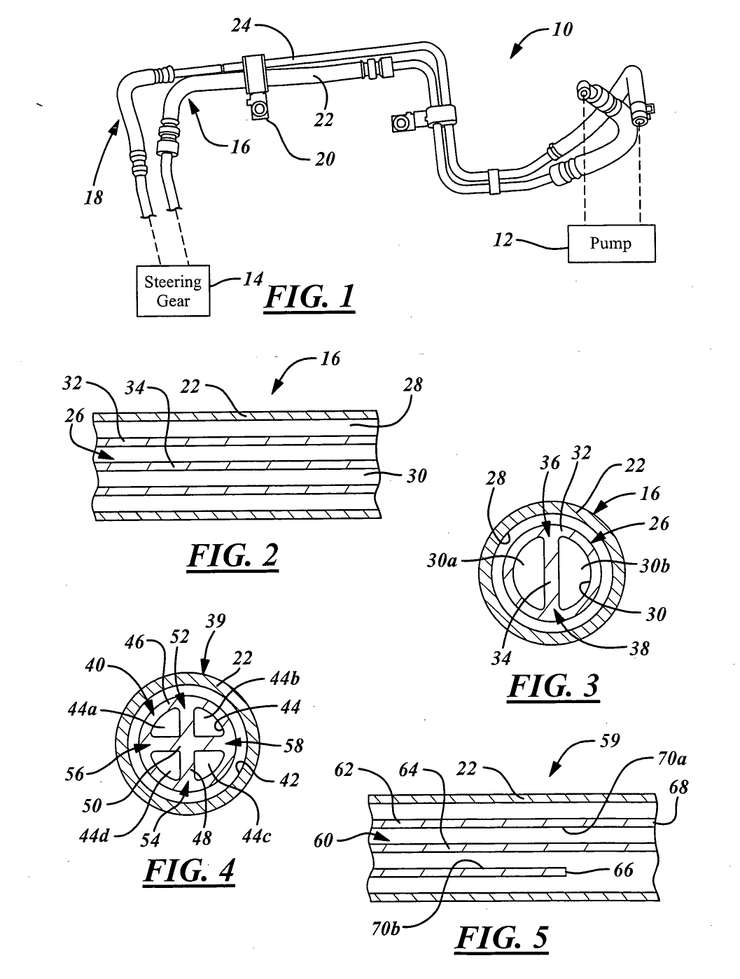

Referring now to the drawings wherein like reference numerals are used to identify identical components in the various views, FIG. 1 illustrates a power steering assembly 10 in accordance with the present invention. Assembly 10 is particularly adapted for use in vehicles. It should be understood, however, that the present invention may be used in non-vehicular applications where steering is required. Assembly 10 is provided to assist the operator of a vehicle or other device in steering the vehicle or device by providing additional motive force responsive to operator actions. Assembly 10 may include a pump 12, a steering gear 14, supply and return hose assemblies 16, 18. Assembly 10 may also include one or more brackets 20 for attachment of the assembly within the motor vehicle (not shown).

Pump 12 is provided to produce fluid flow to provide force required for operation of gear 14. Pump 12 is conventional in the art and may be driven responsive to rotation of an engine crankshaft (not shown) or other power output member of the engine. Pump 12 may comprise any of a variety of conventional pumps including roller pumps, vane pumps, slipper pumps, and gear pumps.

Steering gear 14 is provided to convert rotary motion from a steering wheel (not shown) into linear motion to move a steering linkage (not shown) coupled to one or more wheels (not shown). Gear 14 is also conventional in the art and may comprise any of a variety of conventional steering gears including recirculating ball gears, worm and roller gears and rack and pinion steering gears. Gear 14 includes a housing defining a pair of female inlets configured to receive one end of hose assemblies 16, 18.

Hose assemblies 16, 18 are provided to transmit fluid between pump 12 and steering gear 14 and are disposed between pump 12 and gear 14. Hose assembly 16 supplies pressurized fluid from 12 to steering gear 14 while hose assembly 18 returns fluid from steering gear 14 to a reservoir of pump 12. Hose assemblies 16, 18 each include at least one hose 22, 24, respectively. Alternatively, a plurality of hoses may be connected together to provide hose assemblies 16, 18. The hose may be comprised of various metal tubing and synthetic rubber which is crimped together and/or overlaid at connection points. Alternatively, the hose assemblies may be comprised of a continuous piece of tubing consisting of metal, polymer, synthetic rubber or combinations thereof.

Referring now to FIGS. 2-3, in accordance with the present invention, hose assemblies 16, 18 may further include at least one tuning conduit 26. In the illustrated embodiment and subsequent description, conduit 26 is illustrated as a component of assembly 16. It should be understood, however, that a similar conduit could also be used within hose assembly 18 in a similar manner. Conduit 26 is disposed within the hose 22 of assembly 16 and is provided at a predetermined length that is based on the corresponding length of the hose 22 for providing the proper attenuation of fluid pulses. Conduit 26 can be comprised of various materials known in the art including but not limited to flexible polymeric materials. Conduit 26 defines concentric outer 28 and inner 30 fluid passages within hose 22.

Referring to FIG. 3, conduit 26 includes an annular wall 32 that may be substantially circular. Conduit 26 further includes an integral cross wall 34 such that annular wall 32 and cross-wall 34 comprise a single, unitary structure that may be fabricated through an extrusion process or other fabrication process known in the industry. Cross wall 34 extends between a first point 36 and a second point 38 on annular wall 32 of conduit 26. In the illustrated embodiment, points 36, 38 are diametrically opposite and cross-wall 34 extends diametrically across annular wall 32 intersecting the diametrical center of annular wall 32. It should be understood, however, that cross wall 34 could extend between points that are not diametrically opposite. Cross wall 34 subdivides inner passage 30 into a pair of parallel, longitudinally extending fluid passages 30a, 30b. The creation of multiple fluid passages allows tuning over a broader range of frequencies than conventional systems because each fluid passage 30a, 30b may be individually configured or tuned.

Referring to FIG. 4, a hose assembly 39 in accordance with another embodiment of the present invention is shown. Assembly 39 is similar to assembly 16 and reference may be made to the description hereinabove for like components such as hose 22. Assembly 39 includes a tuning conduit 40. Conduit 40 is disposed within hose 22 of assembly 39 and is provided at a predetermined length that is based on the corresponding length of the hose 22 for providing the proper attenuation of fluid pulses. Conduit 40 can again be comprised of various materials known in the art including but not limited to flexible polymeric materials. Conduit 40 defines concentric outer 42 and inner 44 fluid passages within hose 22.

Conduit 40 includes an annular wall 46 that may be substantially circular. Conduit 40 further includes a pair of integral cross wall 48, 50 such that annular wall 46 and cross-walls 48, 50 comprise a single, unitary structure that may be fabricated through an extrusion process or other fabrication process known in the industry. Cross wall 48 extends between a first point 52 and a second point 54 on annular wall 46 of conduit 40. In the illustrated embodiment, points 52, 54 are diametrically opposite and cross-wall 48 extends diametrically across annular wall 46 intersecting the diametrical center of annular wall 46. Similarly, cross-wall 50 extends between a first point 56 and a second point 58 of annular wall 46 of conduit 40. In the illustrated embodiment, points 56, 58 are diametrically opposite and cross-wall 50 extends diametrically across annular wall 46 intersecting the diametrical center of annular wall 46 and intersecting cross-wall 48 perpendicular to cross-wall 48. It should be understood, however, that one or both of cross-walls 46, 48 could extend between points that are not diametrically opposite and that cross-walls 46, 48 may not intersect. Cross walls 48, 50 subdivide inner passage 44 into a four parallel, longitudinally extending fluid passages 44a, 44b, 44c, 44d. The creation of multiple fluid passages again allows tuning over a broader range of frequencies than conventional systems because each fluid passage 44a, 44b, 44c, 44d may be individually configured or tuned.

The fluid passages 30a, 30b or 44a, 44b, 44c, 44d may be equal in length. Alternatively, and with reference to FIG. 5, the length of the fluid passages may vary in accordance with another embodiment of the present invention. As shown in FIG. 5, a hose assembly 59 in accordance with another embodiment of the invention may include a tuning conduit 60 that is similar in structure to tuning conduit 26 described hereinabove with an annular wall 62 and a cross-wall 64. An arcuate portion 66 of annular wall 62 may be made longitudinally shorter than another arcuate portion 68 such that the length of fluid passages 70a, 70b formed by cross-wall 64 varies enabling attenuation of different frequency bands.

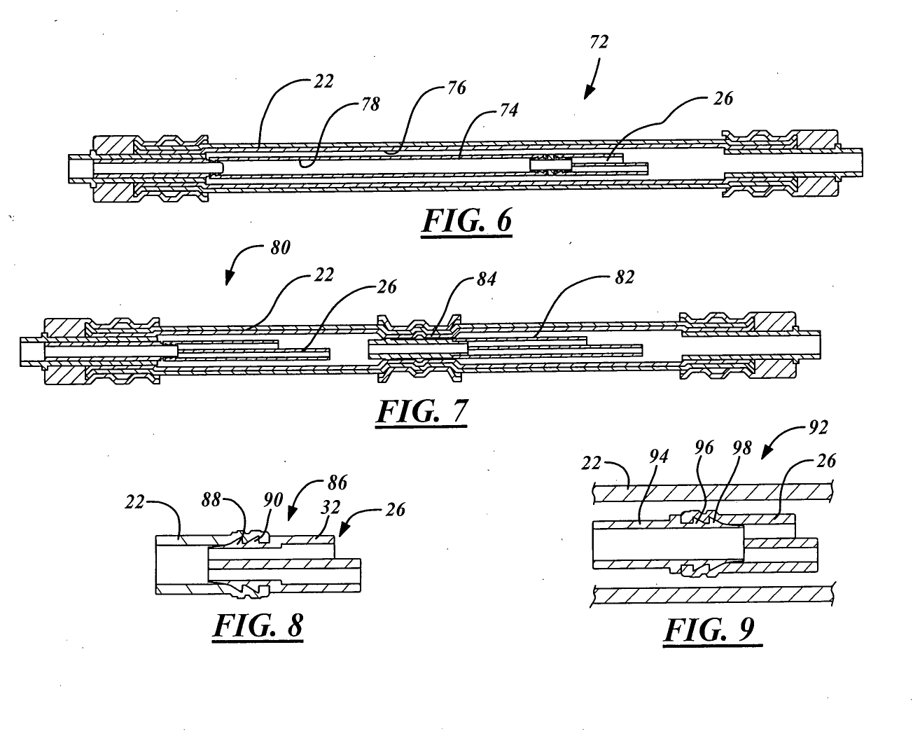

Referring now to FIG. 6, a hose assembly 72 in accordance with another embodiment of the invention is shown in which multiple tuning conduits are disposed within a hose and coupled together. Assembly 72 is similar to assembly 16 and reference may be made to the description hereinabove for like components such as hose 22 and tuning conduit 26. Assembly 72 may include another tuning conduit 74. Conduit 74 is disposed within hose 22, is annular, and defines concentric outer and inner fluid passages 76, 78. Conduit 74 may be substantially circular in shape. Unlike conduit 26, the inner fluid passage 78 of conduit 74 is not further subdivided. One end of conduit 74 is coupled to one end of conduit 26 using any of a variety of conventional methods for joining polymeric components. Although conduit 74 is illustrated as having a single inner flow passage 78 that is not subdivided, it should be understood that conduit 74 may alternatively assume the form of conduit 26, conduit 40 or another conduit having multiple parallel, longitudinally extending fluid passages.

Referring now to FIG. 7, a hose assembly 80 in accordance with another embodiment of the invention is shown in which multiple tuning conduits are disposed within a hose at least some of which are uncoupled from one another. Assembly 80 is also similar to assembly 16 and reference may be made to the description hereinabove for like components such as hose 22 and tuning conduit 26. Assembly 80 may include another tuning conduit 82. Conduit 82 is disposed within hose 22 and may assume the same form as tuning conduit 26. Alternatively, conduit 82 may assume the same form as conduit 40 or a different construction in which the inner fluid passage of conduit 82 is subdivided into multiple parallel, longitudinally extending fluid passages. Assembly 80 may also include a restrictor 84. Restrictor 84 may be disposed about at least a portion of a tuning conduit between the tuning conduit and hose 22 and limits fluid flow within the outer fluid passage defined between the tuning conduit and hose 22. In the illustrated embodiment, restrictor 84 is disposed about a tuning conduit having an inner fluid passage that is not further subdivided. It should be understood, however, that restrictor 84 may be used in any of the hose assemblies described herein and may be disposed about any of the tuning conduits disclosed herein including conduit 26, conduit 40 or another conduit having multiple parallel, longitudinally extending fluid passages. It should also be understood that more than one restrictor 84 may be disposed within hose assembly 80.

Referring now to FIG. 8, a hose assembly 86 in accordance with another embodiment of the invention is shown illustrating a potential coupling between a hose and a tuning conduit. Assembly 86 is also similar to assembly 16 and reference may be made to the description hereinabove for like components such as hose 22 and tuning conduit 26. As illustrated, conduit 26 may define one or more radially outwardly extending barbs 88, 90 proximate one end. Barbs 88, 90 may extend about a portion or all of the circumference of annular wall 32 of tuning conduit 26 and may also comprise a plurality or arcuately spaced segments. Barbs 88, 90 are longitudinally spaced from one another and project rearwardly from the end of conduit 26. Hose 22 is fitted over barbs 88, 90 to secure hose 22 and tuning conduit 26 together.

Referring now to FIG. 9, a hose assembly 92 in accordance with another embodiment of the invention is shown illustrating another potential coupling between a hose and a tuning conduit. Assembly 92 is also similar to assembly 16 and reference may be made to the description hereinabove for like components such as hose 22 and tuning conduit 26. As illustrated, the hose may include an insert 94 disposed within hose 22 and coupled to hose 22. Insert 94 may define one or more radially outwardly extending barbs 96, 98 proximate one end. Barbs 96, 98 may again extend about a portion or all of the circumference of inset 94 and may also comprise a plurality or arcuately spaced segments. Barbs 96, 98 are longitudinally spaced from one another and project rearwardly from the end of insert 94. Tuning conduit 26 (or another tuning conduit having multiple parallel, longitudinally extending fluid passages) is fitted over barbs 96, 98 to secure the conduit to insert 94 and hose 22.

A hose assembly in accordance with the present invention is a significant improvement over conventional systems for attenuating noise in power steering assemblies. The inventive assembly enables attenuation of fluid pressure pulses over a broader spectrum of frequencies thereby further reducing audible noise.

While the invention has been particularly shown and described with reference to the preferred embodiments thereof, it is well understood by those skilled in the art that various changes and modifications can be made in the invention without departing from the spirit and scope of the invention. For example, additional cross-walls could be provided to further subdivide the inner fluid passage defined by the tuning conduit provided that the size of the fluid passages is not reduced to such a size that hydraulic fluid contamination may become an issue. In particular, the inner fluid passage should not be subdivided to a point in which the tuning conduit approximately a capillary fluid flow device.

We claim:

1. A hose assembly for attenuation of fluid pressure pulses in a power steering system, comprising:
a hose disposed between a fluid pump and a power steering gear, said hose transmitting fluid between said pump and said power steering gear; and,
a first tuning conduit disposed within said hose and defining concentric outer and inner fluid passages within said hose, said first tuning conduit having an annular wall and an integral first cross wall extending between first and second points on said annular wall to subdivide said inner fluid passage into first and second parallel, longitudinally extending fluid passages.

2. The hose assembly of claim 1, further comprising a second cross wall integral with said annular wall and extending between a third point on said annular wall and one of said first point and a fourth point on said annular wall to further subdivide said inner fluid passage and form a third longitudinally extending fluid passage parallel to said first and second fluid passages.

3. The hose assembly of claim 2 wherein said first and second cross walls further subdivide said inner fluid passage to form a fourth longitudinally extending fluid passage parallel to said first, second, and third fluid passages.

4. The hose assembly of claim 2 wherein said second cross wall intersects said first cross wall.

5. The hose assembly of claim 4 wherein said first and second cross walls intersect at a diametrical center of said annular wall.

6. The hose assembly of claim 4 wherein said first and second cross walls are perpendicular to one another.

7. The hose assembly of claim 1 wherein said first and second points of said annular wall are diametrically opposite.

8. The hose assembly of claim 1 wherein said first and second fluid passages are equal in length.

9. The hose assembly of claim 1 wherein one of said first and second fluid passages is longer than another of said first and second fluid passages.

10. The hose assembly of claim 1, further comprising a second tuning conduit disposed within said hose and coupled to said first tuning conduit.

11. The hose assembly of claim 10 wherein second tuning conduit defines concentric outer and inner fluid passages within said hose, said inner fluid passage defined by said second tuning conduit is in fluid communication with said inner fluid passage defined by said first fluid conduit and said inner fluid passage defined by said second tuning conduit is not further subdivided.

12. The hose assembly of claim 1, further comprising a second tuning conduit disposed within said hose and defining concentric outer and inner fluid passages within said hose, said second tuning conduit having an annular wall and an integral first cross wall extending between first and second points on said annular wall of said second tuning conduit to subdivide said inner fluid passage defined by said second tuning conduit into first and second parallel, longitudinally extending fluid passages within said second tuning conduit

13. The hose assembly of claim 1, further comprising a restrictor disposed between said first tuning conduit and said hose, said restrictor limiting fluid flow within said outer fluid passage.

14. The hose assembly of claim 1 wherein said first tuning conduit defines a radially outwardly extending barb proximate one end, said hose fitted over said barb.

15. The hose assembly of claim 1, further comprising an insert disposed within said hose, said insert defining a radially outwardly extending barb and said first tuning conduit fitted over said barb.

16. A power steering assembly comprising:
a fluid pump;
a power steering gear; and,
a hose disposed between said fluid pump and said power steering gear, said hose transmitting fluid between said pump and said power steering gear; and,
a first tuning conduit disposed within said hose and defining concentric outer and inner fluid passages within said hose, said first tuning conduit having an annular wall and an integral first cross wall extending between first and second points on said annular wall to subdivide said inner fluid passage into first and second parallel, longitudinally extending fluid passages.

17. The power steering assembly of claim 11, further comprising a second cross wall integral with said annular wall and extending between a third point on said annular wall and one of said first point and a fourth point on said annular wall to further subdivide said inner fluid passage and form a third longitudinally extending fluid passage parallel to said first and second fluid passages.

18. The power steering assembly of claim 16 wherein one of said first and second fluid passages is longer than another of said first and second fluid passages.

19. The power steering assembly of claim 16, further comprising a second tuning conduit disposed within said hose and coupled to said first tuning conduit.

20. The power steering assembly of claim 1, further comprising a second tuning conduit disposed within said hose and defining concentric outer and inner fluid passages within said hose, said second tuning conduit having an annular wall and an integral first cross wall extending between first and second points on said annular wall of said second tuning conduit to subdivide said inner fluid passage defined by said second tuning conduit into first and second parallel, longitudinally extending fluid passages within said second tuning conduit
